(19) United States
(12) Patent Application Publication
(10) Pub. No.: US 2021/0145194 A1
(43) Pub. Date: May 20, 2021

(54) HOTPOT WARE

(71) Applicant: Yung-Liang CHEN, Hsinchu City (TW)

(72) Inventor: Yung-Liang CHEN, Hsinchu City (TW)

(21) Appl. No.: 16/748,286

(22) Filed: Jan. 21, 2020

(30) Foreign Application Priority Data
Nov. 14, 2019 (TW) 108215070

(51) Int. Cl. A47G 19/02; A47J 27/00

(52) U.S. Cl. CPC A47G 19/025; A63J 5/025; A47J 27/002

(57) ABSTRACT

The invention relates to a hotpot ware. The hotpot ware includes a basin-shaped main body adapted for holding and heating a liquid foodstuff, wherein the main body defines a top opening and is integrally formed with a radially outwardly extending rim along the top opening; a dry ice reservoir mounted on and adapted for heat exchange with the rim; and a passageway connected to the dry ice reservoir and adapted for discharge of gasified dry ice. By establishing a heat exchange relationship between the basin-shaped main body and the dry ice reservoir, dry ice accommodated in the dry ice reservoir would rapidly sublimates as the basin-shaped main body is heated, and then a large amount of white vaporous carbon dioxide gas is discharged outward through the passageway, thereby creating an amazing visual effect.

### PRIORITY CLAIM

This application claims priority to R.O.C. Patent Application No. 108215070 filed Nov. 14, 2019, the entirety of which is incorporated herein by reference.

### FIELD OF THE INVENTION

The present invention relates to a structural improvement of a hotpot ware, which is provided with a delicate mechanism for gasifying dry ice, so that the dry ice quickly sublimates as the hotpot ware is heated, and then a large amount of white vaporous carbon dioxide gas is discharged, thereby creating an amazing visual effect.

### BACKGROUND OF THE INVENTION

Hotpot is a traditional Chinese diet. Usually, water or special soup is heated up by a hotpot ware to cook food. Hotpot culture is characterized by eating while cooking. Because the hotpot ware itself has thermal insulation effect, the food is still steaming hot while eating, so it is especially popular in winter. The hotpot diet is also rich in nutrition, a variety of ingredients are mixed and cooked in the hotpot ware and eaten immediately, without losing nutrition. To this day, Chinese hotpot culture has developed a wide variety of ingredients, and everyone can choose their favorite ingredients to be cooked in the hotpot ware for enjoyment. Hotpot culture is also an ideal medium for gathering and socializing. Friends and relatives sit in a circle around the hotpot, not only sharing food, but also sharing life experiences and daily topics, maintaining the friendship of everyone, full of liveliness and fun.

Since the hotpot culture has a social function to maintain friendship, the joyful atmosphere of enjoying the hotpot becomes particularly important. According to the current hotpot culture, it generally focuses on providing a rich and delicious variety of ingredients with a comfortable dining environment to create a joyful atmosphere. At most, only music performances or programs are provided to liven up the atmosphere, novel and creative atmosphere is rarely created through the structural improvement of a hotpot ware. Therefore, there is still a need in the related art for improved hotpot wares.

### SUMMARY OF THE INVENTION

In response to the industrial needs set forth above, the invention provides a hotpot ware, which is provided with a simple and safe mechanism for creating a novel and interesting dining experience. The hotpot ware comprises: a basin-shaped main body adapted for holding and heating a liquid foodstuff, wherein the main body defines a top opening and is integrally formed with a radially outwardly extending rim along the top opening; a dry ice reservoir mounted on and adapted for heat exchange with the rim, wherein the dry ice reservoir comprises an inlet for receiving solid dry ice, and an outlet through which gasified dry ice leaves the dry ice reservoir; and a passageway comprising a first end connected to the outlet of the dry ice reservoir and adapted for receiving the gasified dry ice, and a second end opposite to the first end and disposed outwardly beyond the rim, wherein the second end is arranged in fluid communication with the first end and adapted for discharge of the gasified dry ice from the passageway. According to the invention, by establishing a heat exchange relationship between the basin-shaped main body and the dry ice reservoir, the dry ice accommodated in the dry ice reservoir would rapidly sublimates as the basin-shaped main body is heated, and then a large amount of white vaporous carbon dioxide gas is discharged outwards through the passageway, thereby creating an amazing visual effect.

In one preferred embodiment, the basin-shaped main body further comprises a coupling member having a retaining portion for engaging the rim and an orientation portion for combining with and orienting the second end. In a more preferred embodiment, the rim is outwardly formed with a flange to allow the retaining portion to engage the flange.

In one preferred embodiment, the passageway extends along the rim. In a more preferred embodiment, the dry ice reservoir is configured as a communication tube extending on the rim. In another more preferred embodiment, the dry ice reservoir is configured as a hollow passageway embedded within the rim, and the passageway is configured as another hollow passageway embedded in the coupling member.

In one preferred embodiment, the dry ice reservoir further comprises a cover for generally closing the inlet.

In one preferred embodiment, the basin-shaped main body is partitioned into a plurality of compartments by one or more partition plates.

In one preferred embodiment, the dry ice reservoir is configured as an annular groove, and the inlet is located at a top of the annular groove, and the dry ice reservoir further comprises a cover for generally closing the inlet. In a more preferred embodiment, the annular groove has a bottom surface formed along its inner circumference with a downwardly protruding wall adapted for being snapped and fixed on an inner circumference of the rim.

In one preferred embodiment, the annular groove is generally U-shaped when viewed in cross-section.

### BRIEF DESCRIPTION OF THE DRAWINGS

The present invention will become more readily apparent to those ordinarily skilled in the art after reviewing the following detailed description and accompanying drawings, in which:

FIG. 1 is a perspective view of a hotpot ware according to a first preferred embodiment of the invention;

FIG. 2 is an exploded view of the hotpot ware according to the first preferred embodiment of the invention;

FIG. 3 is a partially enlarged view of the hotpot ware according to the first preferred embodiment of the invention;

FIG. 4 is a partially enlarged view of the hotpot ware according to a second preferred embodiment of the invention;

FIG. 5 is a top view of the hotpot ware according to a third preferred embodiment of the invention;

FIG. 6 is an exploded view of the hotpot ware according to a fourth preferred embodiment of the invention; and

FIG. 7 is a partially enlarged view of the hotpot ware according to the fourth preferred embodiment of the invention.

### DETAILED DESCRIPTION OF PREFERRED EMBODIMENTS

Unless specified otherwise, the following terms as used in the specification and claims are given the following definitions. It should be noted that the indefinite article “a” or “an” as used in the specification and claims is intended to mean one or more than one, such as “at least one,” “at least two,” or “at least three,” and does not merely refer to a singular one. In addition, the term “having/has” as used in each claim is defined as transitional words “including/includes (open language)” or “comprising/comprises (open language)” and do not exclude unrecited additional elements.

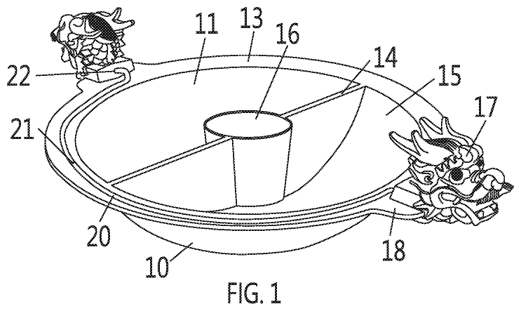

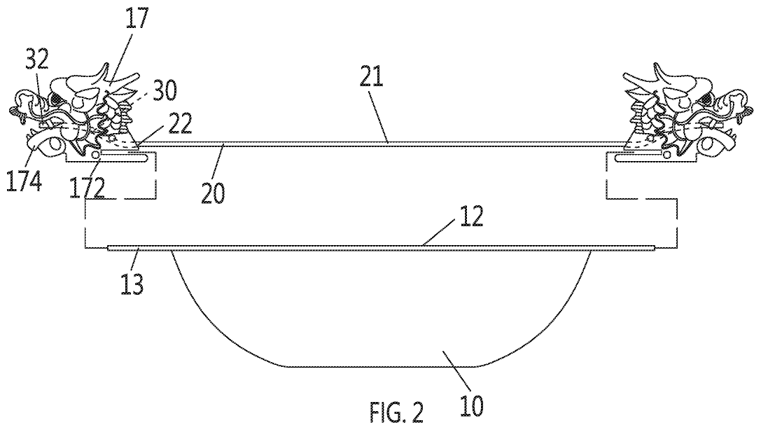

FIGS. 1 and 2 are perspective view and exploded view of a hotpot ware according to a first preferred embodiment of the invention, which show that the hotpot ware according to the invention comprises a basin-shaped main body 10, a dry ice reservoir 20 and a passageway 30.

The basin-shaped main body 10 is configured to be suitable for holding a liquid foodstuff, for receiving a heat source (not shown in the figures) and for transferring the heat energy received from the heat source to the liquid foodstuff, so that the liquid foodstuff is cooked at an elevated temperature. The basin-shaped main body 10 defines an internal space 11 and a top opening 12, so that food can be taken into or taken out of the internal space 11 via the top opening 12. The term “liquid foodstuff” as used herein may refer to an edible material that is substantially in liquid state, such as water, soup, sauce, edible oil, and the like. The liquid foodstuff may be suspended or settled with solid food ingredients visible or invisible to the naked eyes, such as hotpot ingredients and particles of soup additives. The basin-shaped main body 10 is further integrally formed with a radially outwardly extending rim 13 along the top opening 12. Preferably, the rim 13 completely surrounds an entire perimeter of the top opening 12. According to the invention, the rim 13 is configured to provide a working point for holding, so that a user can move the basin-shaped main body 10 by holding the rim 13 with bare hands or by using a tool. More importantly, as described below, the dry ice reservoir 20 may be mounted on the rim 13, so as to allow heat exchange between the dry ice reservoir 20 and the rim 13. The basin-shaped main body 10 may be made of any common cookware material that can transfer thermal energy and meet food safety regulations, which includes but is not limited to metal material with high thermal conduction coefficient and non-metal material with high specific heat, such as heat-resistant glass and ceramics. The basin-shaped main body 10 may be manufactured by a conventional cookware manufacturing process. In one preferred embodiment, the basin-shaped main body 10 is made of a metal material such as stainless steel, cast iron, wrought iron, pure copper or copper alloy, aluminum alloy, and the like, and through the conventional metal forging, stamping, or casting process. The basin-shaped main body 10 may vary in contour and depth, as long as it can achieve the purposes of holding and heating the liquid foodstuff. In some embodiments, the inner space 11 of the basin-shaped main body 10 may be further divided into several compartments 15 by one or more partition plates 14 for holding different types of liquid foodstuff, such as several hotpot soups with different flavors. In one embodiment, the inner space 11 is partitioned with a central compartment 16 concentric with the basin-shaped main body 10.

The dry ice reservoir 20 is adapted for accommodating block-shaped or granular solid dry ice. The term “dry ice” or “solid dry ice” as used herein may refer to the solid state of carbon dioxide. When heated under ambient pressure, dry ice will directly sublimate from solid state to gaseous carbon dioxide, which is referred to herein as “gasified dry ice”. Due to the nearly 800-fold increase in volume during the sublimation process, dry ice is often used to generate a large amount of harmless white vaporous carbon dioxide gas, thus creating dramatic effects. According to the invention, the dry ice reservoir 20 is configured to include an inlet 21 adapted for receiving the solid dry ice, and an outlet 22 through which the gasified dry ice may leave the dry ice reservoir 20. The dry ice reservoir 20 may further include a cover 24 for generally closing the inlet 21 to prevent the gasified dry ice from dissipating through the inlet 21. The dry ice reservoir 20 is mounted on the rim 13 to allow heat exchange with the rim 13. Preferably, the dry ice reservoir 20 is directly fixed to the rim 13, such as welded on the rim 13, thereby being brought in direct contact with the rim 13 to effect the heat exchange. By virtue of this structural arrangement, when the basin-shaped main body 10 is subjected to heat, thermal energy will be transferred to the dry ice reservoir 20 via the rim 13, so that the solid dry ice accommodated in the dry ice reservoir 20 is sublimated to the gasified dry ice by heat, and then the gasified dry ice leaves the dry ice reservoir 20 via the outlet 22. In order to rapidly achieve the heat exchange, the dry ice reservoir 20 may be made of metal material with high thermal conduction coefficient, such as stainless steel, cast iron, wrought iron, pure copper and copper alloy.

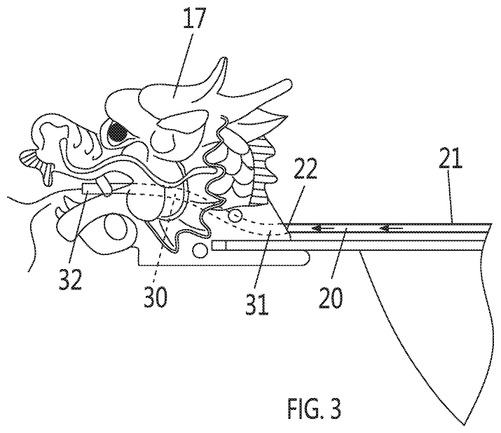

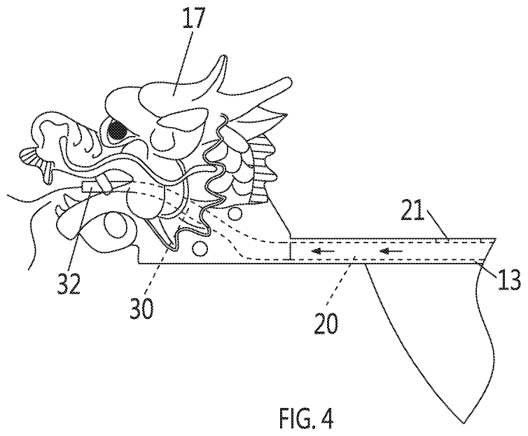

The passageway 30 is adapted to guide the white vaporous gasified dry ice generated by sublimation from the dry ice reservoir 20 to a desired discharge position. The passageway 30 includes a first end 31 and a second end 32 opposite to the first end 31, with the two ends being in fluid communication with each other. The first end 31 is connected to the outlet 22 of the dry ice reservoir 20 for receiving the gasified dry ice leaving from the outlet 22. The gasified dry ice moves to the second end 32 along the passageway 30 and is discharged to the ambient from the second end 32. The second end 32 is arranged to extend outwardly beyond the rim 13, so that the gasified dry ice can be ejected outwardly from the basin-shaped main body 10 to produce a visual effect of vaporous diffusion. In order to orient the second end 32, the basin-shaped main body 10 may further include a coupling member 17. In one embodiment, the coupling member 17 includes a retaining portion 172 adapted for securing the coupling member 17 to the rim 13, and an orientation portion 174 configured for combining with and orienting the second end 32. In this case, the rim 13 may be outwardly formed with a flange 18 to allow the retaining portion 172 to engage the flange 18. In one preferred embodiment, the passageway 30 extends along the rim 13 and is preferably fixed to the rim 13. In a more preferred embodiment shown in FIG. 3, the passageway 30 is configured as a communication tube extending on the ring 13. In another more preferred embodiment shown in FIG. 4, the dry ice reservoir 20 is configured as a hollow passageway embedded within the rim 13, and the passageway 30 is configured as another hollow passageway embedded in the coupling member 17 and communicating with the dry ice reservoir 20.

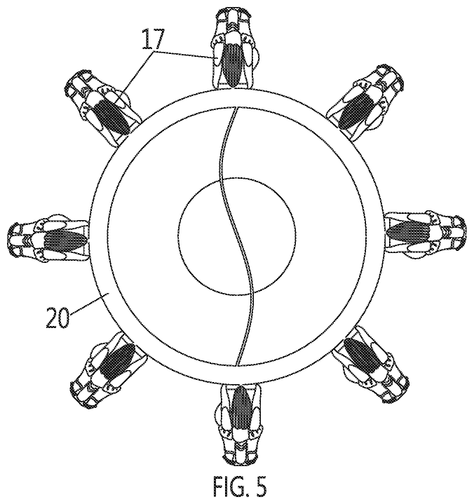

It is worth noting that the coupling member 17 may vary in configuration to increase the interest and artistry of the invention. As shown in FIGS. 1 and 2, the coupling member 17 is configured to have a dragon head configuration, and the second end 32 is oriented by the orientation portion 174 configured into a dragon mouth configuration. When the gasified dry ice is discharged from the second end 32, the visual effect of a flying dragon mounting the clouds and discharging mist is demonstrated. The quantity of the coupling member(s) 17 may vary as needed. In the preferred embodiment shown in FIGS. 1 and 2, two coupling members 17 arranged opposite to each other are provided. In another preferred embodiment shown in FIG. 5, the coupling members 17 are provided in a quantity up to eight. The quantities of the dry ice reservoir 20 and the passageway 30 may also vary, depending upon the quantity of the coupling member(s) 17. In the preferred embodiment shown in FIGS. 1 and 2, a common dry ice reservoir 20 is provided with two outlets 22, and the gasified dry ice is discharged through two passageways 30.

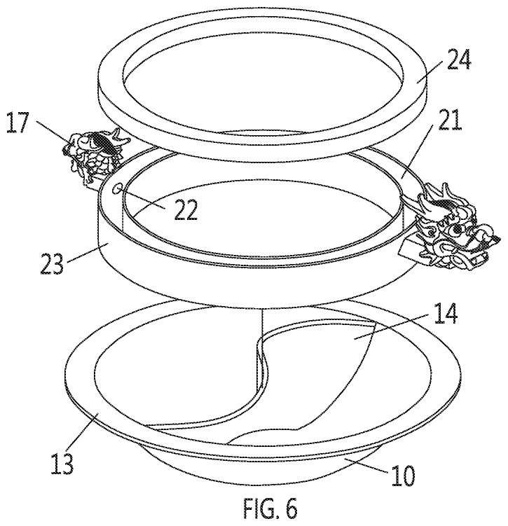

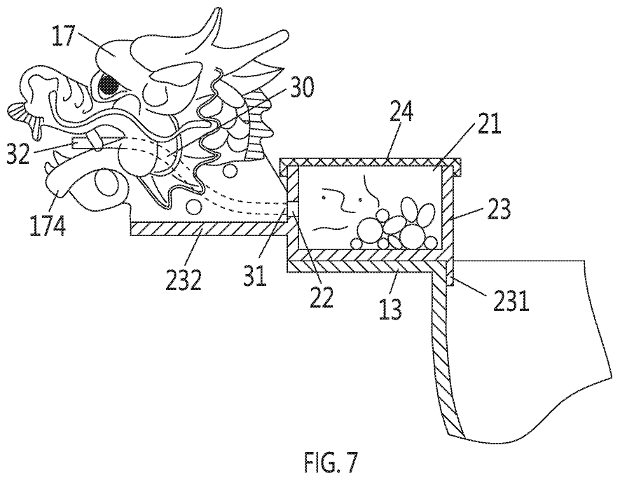

Furthermore, in the preferred embodiment shown in FIGS. 6 and 7, the dry ice reservoir 20 is configured as an annular groove 23, and the inlet 21 is located at a top of the annular groove 23. A cover 24 may be provided to generally close the inlet 21. The annular groove 23 is generally U-shaped when viewed in cross-section and has a bottom surface conformed in shape with the rim 13. The bottom surface of the annular groove 23 has an inner circumference formed with a downwardly protruding wall 231, so that the annular groove 23 can be tightly snapped and fixed onto an inner circumference of the rim 13. The annular groove 23 can be supported and positioned by the partition plate 14 from below. The cover 24 is also conformed in shape with the rim 13 to form an annular sheet body. The annular groove 23 further includes one or more coupling members 17. In the embodiment shown in FIGS. 6 and 7, the coupling member 17 can be fixed on an outer circumference of the annular groove 23. A bottom plate 232 may extend outwardly from the outer circumference of the annular groove 23 and is adapted to support the coupling member 17 from below. The coupling member 17 has the orientation portion 174 adapted for combining with and orienting the second end 32, and the passageway 30 is configured as a hollow passageway embedded in the coupling member 17.

During use, before a hotpot is served on the table, solid dry ice may be placed into the dry ice reservoir 20, and then a heat source can be turned on to provide heat to the basin-shaped main body 10. As the basin-shaped main body 10 is gradually heated and the temperature rises, thermal energy can not only heat the liquid foodstuff held in the basin-shaped main body 10, but is also transferred to the dry ice reservoir 20 via the rim 13, so that the solid dry ice accommodated in the dry ice reservoir 20 is sublimated by heat to generate a large amount of gasified dry ice. The gasified dry ice will flow to where the concentration is lower and be discharged through the second end 32 of the passageway 30. A large amount of white vaporous carbon dioxide discharged in a short period of time can create stunning visual effects, it is even more magnificent with the dragon head configuration of the coupling member 17, bringing unexpected surprises and climaxes to the hotpot feast, creating joyful dining atmosphere for both guests and host.

The technical features of the invention are disclosed above. The specification relating to the above embodiments should be construed as exemplary rather than as limitative of the invention, with many variations and modifications being readily attainable by a person with ordinary skill in the art, without departing from the spirit or scope thereof as defined by the appended claims and their legal equivalents.

What is claimed is:

1. A hotpot ware comprising:
a basin-shaped main body adapted for holding and heating a liquid foodstuff, wherein the main body defines a top opening and is integrally formed with a radially outwardly extending rim along the top opening;
a dry ice reservoir mounted on and adapted for heat exchange with the rim, wherein the dry ice reservoir comprises an inlet for receiving solid dry ice and an outlet through which gasified dry ice leaves the dry ice reservoir; and
a passageway comprising a first end connected to the outlet of the dry ice reservoir and adapted for receiving the gasified dry ice, and a second end opposite to the first end and disposed outwardly beyond the rim, wherein the second end is arranged in fluid communication with the first end and adapted for discharge of the gasified dry ice from the passageway.

2. The hotpot ware as claimed in claim 1, wherein the basin-shaped main body further comprises a coupling member having a retaining portion for engaging the rim and an orientation portion for combining with and orienting the second end.

3. The hotpot ware as claimed in claim 2, wherein the rim is outwardly formed with a flange to allow the retaining portion to engage the flange.

4. The hotpot ware as claimed in claim 2, wherein the dry ice reservoir extends along the rim.

5. The hotpot ware as claimed in claim 4, wherein the dry ice reservoir is configured as a communication tube extending on the rim.

6. The hotpot ware as claimed in claim 4, wherein the dry ice reservoir is configured as a hollow passageway embedded within the rim, and the passageway is another hollow passageway embedded in the coupling member.

7. The hotpot ware as claimed in claim 1, wherein the dry ice reservoir is configured as an annular groove, and the inlet is located at a top of the annular groove, and the dry ice reservoir further comprises a cover for generally closing the inlet.

8. The hotpot ware as claimed in claim 7, wherein the annular groove has a bottom surface formed along its inner circumference with a downwardly protruding wall adapted for being snapped and fixed on an inner circumference of the rim.

9. The hotpot ware as claimed in claim 8, wherein the annular groove is generally U-shaped when viewed in cross-section.

10. The hotpot ware as claimed in claim 8, wherein the annular groove further comprises a coupling member having an orientation portion for combining with and orienting the second end, and the passageway is configured as a hollow passageway embedded in the coupling member.

11. The hotpot ware as claimed in claim 8, wherein the basin-shaped main body is partitioned into a plurality of compartments by one or more partition plates.
